(19) United States
(12) Patent Application Publication
(10) Pub. No.: US 2006/0208682 A1
(43) Pub. Date: Sep. 21, 2006

(54) Internal integrated encoder and method of use

(76) Inventor: Kyle Bober, Amston, CT (US)

Correspondence Address: JOHN H CROZIER, 1934 HUNTINGTON TURNPIKE, TRUMBULL, CT, 06611, US

(21) Appl. No.: 11/113,621

(22) Filed: Apr. 25, 2005

Related U.S. Application Data
(60) Provisional application No. 60/564,780, filed on Apr. 23, 2004.

(51) Int. Cl. G05B 19/29

(52) U.S. Cl. 318/602

(57) ABSTRACT

In a preferred embodiment, an apparatus, including: a motor; a code wheel attached to a rear surface of a rotor of the motor; and an read head/circuit board assembly attached to an inside surface of an end bell of the motor, the read head/circuit board assembly disposed so as to read the code wheel. A method of using the encoder is also provided.

### CROSS-REFERENCE TO RELATED APPLICATION

The present application claims the benefit of the filing date of U.S. Provisional Application No. 60/564,780, filed Apr. 23, 2004, and titled INTERNAL INTEGRATED ENCODER.

### BACKGROUND OF THE INVENTION

1. Field of the Invention

The present invention relates to encoders generally and, more particularly, but not by way of limitation, to a novel encoder and method of use thereof.

2. Background Art

An encoder is a feedback device that converts mechanical motion into electronic signals. The encoder is a rotary device that sends digital pulses that relate with incremental angular motion. The encoder consists of a code wheel made of plastic, glass, or metal and has alternating clear and dark stripes that can be detected by an optical sensor that is placed in a read head.

The code wheel can have as few lines as desired up to as many as 4000 lines per inch. The optical sensor must correlate with the code wheel to ensure proper feedback.

Known encoders are mounted externally on a motor. They are cumbersome and produce and awkwardly shaped motor. Such an encoder must be dissembled before it is assembled to the motor. The code wheel has to be attached to a hub that is then attached to the rotor or the extended shaft of the motor. The encoder has a mounting plate that needs to be screwed to the back of the motor. Then, the read head must be screwed onto the mounting plate. Next, the code wheel is attached to the extended shaft and then the cover is snapped on.

A conventional encoder needs many parts, it is cumbersome, and it requires an extra retrofitting of an existing motor.

Accordingly, it is a principal object of the present invention to provide an encoder and method of use that require a minimum of parts.

It is a further object of the invention to provide such an encoder and method of use that can be economically constructed.

Other objects of the present invention, as well as particular features, elements, and advantages thereof, will be elucidated in, or be apparent from, the following description and the accompanying drawing figures.

### SUMMARY OF THE INVENTION

The present invention achieves the above objects, among others, by providing, in a preferred embodiment, an apparatus, comprising: a motor; a code wheel attached to a rear surface of a rotor of said motor; and an read head/circuit board assembly attached to an inside surface of an end bell of said motor, said read head/circuit board assembly disposed so as to read said code wheel. A method of using the encoder is also provided.

### BRIEF DESCRIPTION OF THE DRAWING

Understanding of the present invention and the various aspects thereof will be facilitated by reference to the accompanying drawing figures, provided for purposes of illustration only and not intended to define the scope of the invention, on which:

FIG. 1 is a partially exploded, side elevational view of a conventionally constructed encoder to be attached to a motor.

FIG. 2 is an exploded, side elevational view of an encoder constructed according to the present invention to be attached to a motor.

### DETAILED DESCRIPTION OF THE PREFERRED EMBODIMENTS

Reference should now be made to the drawing figures on which similar or identical elements are given consistent identifying numerals throughout the various figures thereof, and on which parenthetical references to figure numbers, when used, direct the reader to the view(s) on which the element(s) being described is (are) best seen, although the element(s) may be seen on other figures also.

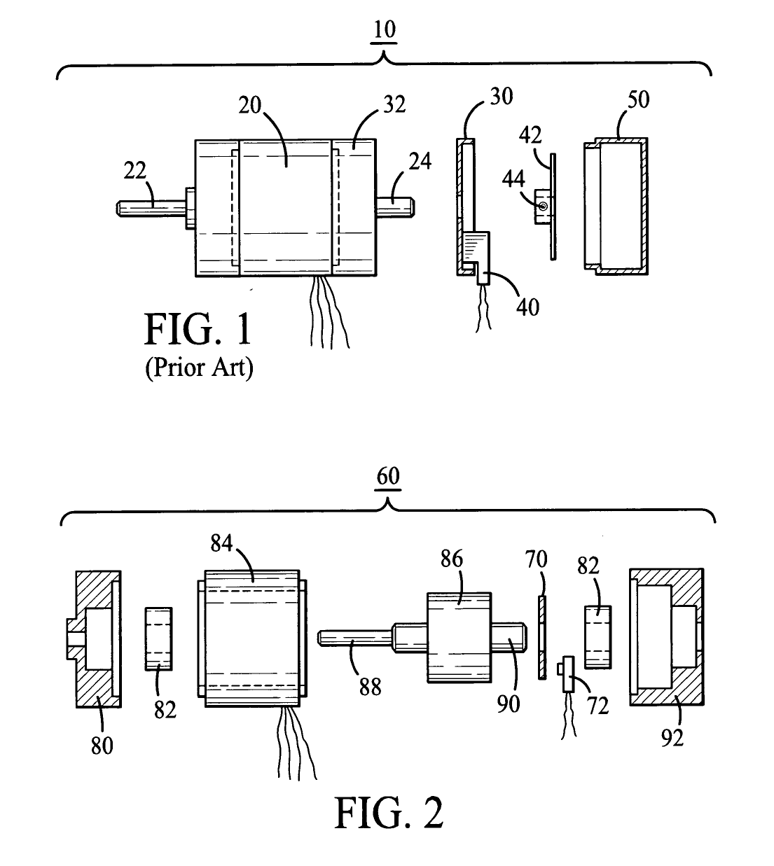

FIG. 1 illustrates a conventionally constructed encoder for attachment to a motor, all generally indicated by the reference numeral 10. Encoder/motor 10 includes a conventionally constructed motor 20 that includes a shaft 22 and an extended shaft/rotor 24 extending therefrom. Motor 20 may be assumed to be a stepper motor. Encoder/motor 10 includes a mounting plate 30 that is to be attached to a rear end bell 32 of motor 20. A read head/circuit board assembly 40 is to be attached to mounting plate 30, while a code wheel 42 is to be attached to extended shaft/rotor 24 by means of a set screw 44. A rear cover 50 that is to be attached to mounting plate 30 completes conventionally constructed encoder/motor 10.

FIG. 2 illustrates the design of the present invention, an encoder/motor, generally indicated by the reference numeral 60. Encoder/motor 60 has only two new parts—a code wheel 70 and a read head/circuit board assembly 72. Conventionally constructed members of the motor are a front end bell 80, two bearings 82, a stator 84, a rotor 86, a shaft 88, an extended shaft/rotor 90, and a rear end bell 92.

Code wheel 70 is preferably adhesively attached to the rear end of rotor 86 and read head/circuit board assembly 72 is attached to the inside of rear end bell 92. When encoder/motor 60 is assembled, no adjustments need to be made. Rear end bell 92 acts the mounting plate, while encoder/motor 60 as a whole provides protection to the internal encoder.

The internal encoder provides a much smaller package. Everything is internal and there are only two parts rather that the seven or eight required by a conventional encoder. The motor provides protection to the encoder from any substances that might ruin the optical read head. The cost and assembly time required to make a motor with an encoder is substantially less.

In the embodiments of the present invention described above, it will be recognized that individual elements and/or features thereof are not necessarily limited to a particular embodiment but, where applicable, are interchangeable and can be used in any selected embodiment even though such may not be specifically shown.

Spatially orienting terms such as “above”, “below”, “upper”, “lower”, “inner”, “outer”, “inwardly”, “outwardly”, “vertical”, “horizontal”, and the like, when used herein, refer to the positions of the respective elements shown on the accompanying drawing figures and the present invention is not necessarily limited to such positions.

It will thus be seen that the objects set forth above, among those elucidated in, or made apparent from, the preceding description, are efficiently attained and, since certain changes may be made in the above construction without departing from the scope of the invention, it is intended that all matter contained in the above description or shown on the accompanying drawing figures shall be interpreted as illustrative only and not in a limiting sense.

It is also to be understood that the following claims are intended to cover all of the generic and specific features of the invention herein described and all statements of the scope of the invention which, as a matter of language, might be said to fall therebetween.

1. An apparatus, comprising:
(a) a motor;
(b) a code wheel attached to a rear surface of a rotor of said motor; and
(c) an read head/circuit board assembly attached to an inside surface of an end bell of said motor, said read head/circuit board assembly disposed so as to read said code wheel.

2. An apparatus, as defined in claim 1, wherein: said code wheel is adhesively attached to said rear surface of said rotor of said motor.

3. A method, comprising:
(a) attaching a code wheel to a rear surface of a rotor of a motor; and
(b) attaching an read head/circuit board assembly to an inside surface of an end bell of said motor, and disposing said read head/circuit board assembly to read said code wheel.

4. A method, as defined in claim 3, further comprising: attaching said code wheel using an adhesive.
